(19) United States
(12) Patent Application Publication
(10) Pub. No.: US 2010/0173241 A1
(43) Pub. Date: Jul. 8, 2010

(54) POSITIVELY-CHARGEABLE TONER FOR DEVELOPING ELECTROSTATIC IMAGE

(75) Inventor: Osamu Ieda, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ZEON CORPORATION, Tokyo-to (JP)

(21) Appl. No.: 12/601,472

(22) PCT Filed: May 29, 2008
(86) PCT No.: PCT/JP2008/059919

§ 371 Date: Nov. 23, 2009

(30) Foreign Application Priority Data
May 29, 2007 (JP) 2007-142603

(51) Int. Cl. G03G 9/08; G03G 9/087; G03G 9/09; G03G 9/097

(52) U.S. Cl. 430/108.4

(57) ABSTRACT

The present invention is to provide a positively-chargeable toner for developing electrostatic images which is applicable to a toner replenishment-type image forming device, is excellent in charge stability of toners and initial charging speed and thus producing less initial fog and being less likely to cause filming on photosensitive members upon replenishment of toners, can impart a stable charging ability to toner particles over time, and thus hardly causes deterioration of image quality due to fog or the like, and therefore is excellent in printing durability even if continuous printing of a large number of prints is performed. A positively-chargeable toner for developing electrostatic images comprising colored resin particles containing a binder resin, a colorant and a charge control agent, and an external additive, wherein the external additive contains fatty acid alkali metal salt particles or fatty acid alkaline earth metal salt particles having a number average primary particle diameter of 0.1 to 1 μm, and a content of the fatty acid alkali metal salt particles or the fatty acid alkaline earth metal salt particles is in the range from 0.01 to 0.5 parts by weight with respect to 100 parts by weight of the colored resin particles.

### TECHNICAL FIELD

The present invention relates to a positively-chargeable toner for developing electrostatic images (hereinafter, it may be simply referred to as “positively-chargeable toner” or “toner”) used for development of latent electrostatic images in electrophotography, the electrostatic recording method, the electrostatic printing process or the like. Particularly, the present invention relates to a positively-chargeable toner for developing electrostatic images which is applicable to a toner replenishment-type image forming device.

### BACKGROUND ART

Image-forming devices such as electrophotographic devices, electrostatic recording devices, electrostatic printing devices, and so on are applied to copying machines, printers, facsimile machines, complex machines thereof and so on. A method of forming a desired image by developing an electrostatic latent image formed on a photosensitive member with a toner for developing an electrostatic image is widely employed.

For example, an electrophotographic device using electrophotography uniformly charges the surface of a photosensitive member generally formed of photoconductive material with any of various means, and then, an electrostatic latent image is formed on the photosensitive member. Next, the electrostatic latent image is developed using a toner. After transferring an image of the toner on a recording material such as paper or the like, the image is fixed by heating or the like. Thus, a copy is obtained.

As toners used for development, there are negatively-chargeable toners and positively-chargeable toners. In recent years, the positively-chargeable toners are preferably used from the viewpoint of inhibiting ozone generation and obtaining the toners excellent in charging ability.

In addition, external additives such as inorganic particles, organic particles or the like having generally smaller particle diameter than that of colored resin particles (toner particles) are externally added (attached by addition) on the surface of the toner particles for the purpose of improving charge stability, flowability and durability of the toners.

In the process of continuous printing of a large number of prints using toners obtained by using a conventional external additive, microparticles of the external additive are buried on and/or released (detached) from the surface of toner particles due to mechanical stress in a development device, such as increase in number of contact of toner particles by agitation or the like. Thereby, functions as external additives decrease and it becomes difficult to impart stable charging ability (charge stability) to toner particles over time.

The toner particles wherein the microparticles of the external additive being buried may cause filming due to the toner particles attaching to the surface of a photosensitive member so that deterioration of image quality due to fog or the like tends to occur. The microparticles of the external additive released (detached) from the surface of the toner particles may cause damage on photosensitive members. Thereby, there are problems that adverse effect on printing performance such as decrease of printing durability of toners may be caused.

Accordingly, development of a toner is demanded, wherein defects such as burial and/or release of the microparticles of the external additive are less likely to occur, the toner can maintain the state in which microparticles of an external additive are suitably attached to the surface of the toner particles over time and the toner can impart a stable charging ability (charge stability) to the toner particles, even if the number of contact of the toner particles by agitation or the like increases in a development device in the process of continuous printing of a large number of prints.

According to the development of the above toner, the toner will be applicable to replenishment-type image forming devices.

A replacement system, wherein a whole cartridge is replaced to new one when the amount of toner becomes small, is employed to toners used for conventional image forming devices. However, in recent years, a toner also applicable to an image forming device which can newly replenish a toner (new toner) with the toner left in small amount (remaining toner) is required as requested from the viewpoint of environment and cost.

In the replenishment-type image forming device, the toner in early stage exhibits excellent charge stability, flowability and durability since microparticles of the external additive are uniformly attached on the surface of the toner particles. However, it becomes difficult for the remaining toner after continuous printing of a large number of prints to impart stable charging ability (charge stability) to toner particles over time since microparticles of the external additive are buried on and/or released due to mechanical stress in a development device.

When the remaining toner is replenished with a new toner, toners having different charging state on the surface of the particles mix so that charge change may occur and charge stability becomes poor. Thus, there is a problem that replenishment of the remaining toner with a new toner has adverse effect on printing performance that upon initial printing soon after replenishment of the toner, the initial charging speed may decrease and initial fog is easily generated so that filming on photosensitive members is easily caused.

Therefore, development of a toner which can be applied to a replenishment-type image forming device is demanded, wherein the toner can maintain the state in which microparticles of an external additive are suitably attached on the surface of colored resin particles of the remaining toners over time, the toner can impart stable charging ability (charge stability) to the toner particles (remaining toners), and charge change is hardly caused upon replenishment of new toners.

Patent Literature 1 discloses a toner obtained by an external addition treatment in which long-chain fatty acid salt is added to toner base particles, and also discloses that 0.1 parts by mass of powders of magnesium stearate are added as the long-chain fatty acid salt with respect to 100 parts by mass of the toner base particles, and then the external addition treatment is carried out.

However, there is no specific description of a corporate name, a product name and an average particle diameter of powders of magnesium stearate in Patent Literature 1, and the description is not clear and sufficient to perform an embodiment.

Patent Literatures 2 and 3 disclose a toner obtained by an external addition treatment in which a metallic soap is added to toner base particles, and also disclose that 0.2 parts by weight of calcium stearate particles (manufactured by NOF Corporation) is added as the metallic soap with respect to 100 parts by weight of the toner base particles, and then the external addition treatment is carried out.

However, the toners disclosed in Patent Literatures 2 and 3 are considered to be a toner wherein the metallic soap is contained in order to improve cleaning property, filming to photosensitive members hardly causes and means for cleaning on photosensitive members is not required, but the toner does not have printing performance sufficient to be applied to a replenishment-type image forming device.

Patent Literature 4 discloses a one-component developer obtained by an external addition treatment in which fatty acid metal salt particles are added to toner particles, and also discloses that 0.3 parts of zinc stearate particles (average particle diameter Ds50: 2.9 μm) are added as the fatty acid metal particles with respect to 100 parts of the toner particles, and then the external addition treatment is carried out.

However, the toner disclosed in Patent Literature 4 is considered to be a toner wherein the fatty acid metal salt particles are contained in order to improve cleaning property, cleaning problems to a photosensitive member are prevented and filming is hardly caused. However, the toner does not have printing performance sufficient to be applied to a replenishment-type image forming device.

Patent Literature 5 discloses a method of producing a spherical toner having negatively charging ability obtained by an external addition treatment in which metallic soap particles are added to toner base particles, and also discloses that 3 g of magnesium stearate (product name: MM-2; manufactured by NOF Corporation; average particle diameter: 1.9 μm) or calcium stearate (product name: MC-2; manufactured by NOF Corporation; average particle diameter: 1.1 μm) is added as the metallic soap particles with respect to 3.0 kg of the toner base particles, and then the external addition treatment is carried out.

However, as a result of researches, the toner obtained by calcium stearate (product name: MC-2; manufactured by NOF Corporation; average particle diameter: 1.1 μm) disclosed in Patent Literature 5 is a toner wherein fog is generated upon initial printing soon after replenishment of the toner and printing durability is poor; thus, the inventor of the present invention found out that the toner is inapplicable to replenishment-type image forming devices.

Patent Literature 1: Japanese patent Application Laid-open (JP-A) No. 2004-219935

Patent Literature 2: JP-A No. 2005-274643

Patent Literature 3: JP-A No. 2005-274722

Patent Literature 4: JP-A No. H9-236942

Patent Literature 5: JP-A No. 2006-201563

### SUMMARY OF INVENTION

### Technical Problem

An object of the present invention is to provide a positively-chargeable toner for developing electrostatic images which is applicable to a toner replenishment-type image forming device, is excellent in charge stability of toners and initial charging speed and thus producing less initial fog and being less likely to cause filming on photosensitive members upon replenishment of toners, can impart a stable charging ability to toner particles over time, and thus hardly causes deterioration of image quality due to fog or the like, and therefore is excellent in printing durability even if continuous printing of a large number of prints is performed.

### Solution to Problem

As a result of diligent researches made to attain the above object, the inventor of the present invention found out that by using a specific amount of fatty acid alkali metal salt particles or fatty acid alkaline earth metal salt particles having specific characteristics as an external additive, initial charging speed can be excellent and thus producing less initial fog and being less likely to cause filming on photosensitive members upon initial printing soon after replenishment of the toners so that a stable charging ability can be imparted to toner particles over time. Thus, even if continuous printing of a large number of prints is performed, deterioration of image quality due to fog or the like is hardly caused, and therefore, printing durability is excellent. Based on the above knowledge, the inventor has reached the present invention.

Specifically, a positively-chargeable toner for developing electrostatic images of the present invention is a positively-chargeable toner for developing electrostatic images comprising colored resin particles containing a binder resin, a colorant and a charge control agent, and an external additive,

wherein the external additive contains fatty acid alkali metal salt particles or fatty acid alkaline earth metal salt particles having a number average primary particle diameter of 0.1 to 1 μm, and a content of the fatty acid alkali metal salt particles or the fatty acid alkaline earth metal salt particles is in the range from 0.01 to 0.5 parts by weight with respect to 100 parts by weight of the colored resin particles.

### ADVANTAGEOUS EFFECTS OF INVENTION

According to the positively-chargeable toner for developing electrostatic images of the present invention, the positively-chargeable toner for developing electrostatic images which is applicable to a toner replenishment-type image forming device, is excellent in charge stability of toners and initial charging speed, and thus producing less initial fog and being less likely to cause filming on photosensitive members upon replenishment of toners, can impart a stable charging ability to toner particles over time, and thus hardly causes deterioration of image quality due to fog or the like, and therefore is excellent in printing durability even if continuous printing of a large number of prints is performed, can be provided.

### DESCRIPTION OF EMBODIMENTS

A positively-chargeable toner for developing electrostatic images of the present invention is a positively-chargeable toner for developing electrostatic images comprising colored resin particles containing a binder resin, a colorant and a charge control agent, and an external additive,

wherein the external additive contains fatty acid alkali metal salt particles or fatty acid alkaline earth metal salt particles having a number average primary particle diameter of 0.1 to 1 μm, and a content of the fatty acid alkali metal salt particles or the fatty acid alkaline earth metal salt particles is in the range from 0.01 to 0.5 parts by weight with respect to 100 parts by weight of the colored resin particles.

Hereinafter, the positively-chargeable toner for developing electrostatic images (hereinafter, it may be simply referred to as “toner”) of the present invention will be explained.

The toner of the present invention can be obtained by containing a specific amount of colored resin particles containing a binder resin, a colorant and a charge control agent, and fatty acid alkali metal salt particles or fatty acid alkaline earth metal salt particles having specific characteristics as an external additive.

Specific examples of the binder resin include resins such as polystyrene, styrene-butyl acrylate copolymers, polyester resins and epoxy resins, which have been conventionally and widely used in toners.

Generally, methods of producing the colored resin particles are broadly classified into dry methods such as a pulverization method and wet methods such as an emulsion polymerization agglomeration method, a dispersion polymerization method, a suspension polymerization method and a solution suspension method. The wet methods are preferable since the toners having excellent printing characteristics such as image reproducibility can be easily obtained. Among the wet methods, polymerization methods such as the emulsion polymerization agglomeration method, the dispersion polymerization method, and the suspension polymerization method are preferable since the toners which have relatively small particle size distribution in micron order can be easily obtained. Among the polymerization methods, the suspension polymerization method is more preferable.

In the emulsion polymerization agglomeration method, the colored resin particles are produced by polymerizing emulsified polymerizable monomers to obtain resin microparticles, and aggregating the resultant resin microparticles with a colorant. Also, the solution suspension method is a method of producing the colored resin particles by forming droplets of a solution in which a toner components such as a binder resin and a colorant are dissolved or dispersed in an organic solvent in an aqueous medium, and removing the organic solvent. Both methods can be performed by known methods.

The colored resin particles of the present invention can be produced by employing the wet methods or the dry method.

In the case of employing “(A) Suspension polymerization method” preferable among the wet methods or “(B) Pulverization method” typical among the dry methods, the following processes are performed.

### (A) Suspension Polymerization Method

### (1) Preparation Process of Polymerizable Monomer Composition

Firstly, a polymerizable monomer, a colorant, a charge control agent and other additives such as a release agent to be added if required, are mixed to prepare a polymerizable monomer composition. Mixing upon preparing the polymerizable monomer composition is performed by means of a media type dispersing machine.

In the present invention, the polymerizable monomer means a compound which can be polymerized and the polymerizable monomer is polymerized to be a binder resin. As a main component of the polymerizable monomer, a monovinyl monomer is preferably used. Examples of the monovinyl monomer include styrene; styrene derivatives such as vinyl toluene and α-methylstyrene; acrylic acid and methacrylic acid; acrylic acid esters such as methyl acrylate, ethyl acrylate, propyl acrylate, butyl acrylate, 2-ethylhexyl acrylate and dimethylaminoethyl acrylate; methacrylic acid esters such as methyl methacrylate, ethyl methacrylate, propyl methacrylate, butyl methacrylate, 2-ethylhexyl methacrylate and dimethylaminoethyl methacrylate; amide compounds such as acrylamide and methacrylamide; and olefins such as ethylene, propylene and butylene. The monovinyl monomer may be used alone or in combination. Among the above, styrene, styrene derivatives, acrylic acid esters or methacrylic acid esters are suitably used as the monovinyl monomer.

In order to prevent hot offset, as a part of the polymerizable monomer, any crosslinkable polymerizable monomer may be preferably used together with the monovinyl monomer. The crosslinkable polymerizable monomer means a monomer having two or more polymerizable functional groups. Examples of the crosslinkable polymerizable monomer include aromatic divinyl compounds such as divinyl benzene, divinyl naphthalene and derivatives thereof; unsaturated carboxylic acid polyesters of polyalcohol such as ethylene glycol dimethacrylate and diethylene glycol dimethacrylate; divinyl compounds other than the above such as N,N-divinylaniline and divinyl ether; and compounds having three or more vinyl groups such as trimethylolpropane trimethacrylate and dimethylolpropane tetraacrylate. The crosslinkable polymerizable monomer may be used alone or in combination of two or more kinds.

In the present invention, it is desirable that the amount of the crosslinkable polymerizable monomer is generally from 0.1 to 5 parts by weight, preferably from 0.3 to 2 parts by weight, with respect to the monovinyl monomer of 100 parts by weight.

Further, as a part of the polymerizable monomer, any macromonomer may be preferably used together with the monovinyl monomer so that the shelf stability and low-temperature fixability of the toner can be well-balanced. The macromonomer is a reactive oligomer or polymer having a polymerizable carbon-carbon unsaturated double bond at the end of a polymer chain and generally a number average molecular weight of 1,000 to 30,000. As the macromonomer, a macromonomer which provides a polymer having higher “Tg” (glass transition temperature) than that of a polymer obtained by polymerization of the monovinyl monomer is preferable.

In the present invention, it is desirable that the amount of the macromonomer is generally in the range from 0.01 to 10 parts by weight, preferably from 0.03 to 5 parts by weight, more preferably from 0.1 to 2 parts by weight, with respect to the monovinyl monomer of 100 parts by weight.

The colorant is used in the present invention. To produce a colored toner, in which four types of toners including a black toner, a cyan toner, a yellow toner and a magenta toner are generally used, a black colorant, a cyan colorant, a yellow colorant and a magenta colorant may be respectively used.

In the present invention, examples of the black colorant to be used include carbon black, titanium black, magnetic powder such as zinc-ferric oxide and nickel-ferric oxide.

Examples of the cyan colorant include compounds such as copper phthalocyanine pigments, derivatives thereof and anthraquinone pigments. The specific examples include C. I. Pigment Blue 2, 3, 6, 15, 15:1, 15:2, 15:3, 15:4, 16, 17:1 and 60.

Examples of the yellow colorant to be used include compounds including azo pigments such as monoazo pigments and disazo pigments, and condensed polycyclic pigments. The specific examples include C. I. Pigment Yellow 3, 12, 13, 14, 15, 17, 62, 65, 73, 74, 83, 93, 97, 120, 138, 155, 180, 181, 185 and 186.

Examples of the magenta colorant to be used include compounds including azo pigments such as monoazo pigments and disazo pigments, and condensed polycyclic pigments. The specific examples include C. I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209 and 251, and C. I. Pigment Violet 19.

In the present invention, the colorant may be used alone or in combination of two or more kinds. The amount of the colorant to be used is preferably in the range from 1 to 10 parts by weight with respect to the monovinyl monomer of 100 parts by weight.

As other additives, the charge control resins are preferably added as the charge control agent since the charge control resins are highly compatible with the binder resin (or polymerizable monomer) and can impart a stable charging ability to the toner particles. The charge control resins are broadly classified into charge control resins having positively charging ability and charge control resins having negatively charging ability. In the present invention, the charge control resins having positively charging ability are preferably added from the viewpoint of obtaining a positively-chargeable toner.

As the charge control resins of the present invention, various types of commercial products can be used. Examples of commercial products manufactured by Fujikura Kasei Co., Ltd. include FCA-161P (product name; a styrene/acrylate resin), FCA-207P (product name; a styrene/acrylate resin), and FCA-201-PS (product name; a styrene/acrylate resin).

In the present invention, the amount of the charge control agent to be used is generally in the range from 0.01 to 10 parts by weight, preferably from 0.03 to 8 parts by weight, with respect to the monovinyl monomer of 100 parts by weight.

As one of other additives, the release agent is preferably added since the releasing characteristic of the toner from a fixing roller at fixing can be improved. As the release agent, one which is generally used as a release agent for the toner may be used without any particular limitation. The examples include natural waxes including animal and plant waxes such as candelilla, carnauba waxes, rice waxes, haze waxes and jojoba; petroleum waxes such as paraffin, microcrystalline and petrolactam and denatured waxes thereof, and synthesized waxes including polyolefin waxes such as low-molecular-weight polyethylene, low-molecular-weight polypropylene and low-molecular-weight polybutylene; Fischer-Tropsch waxes; ester waxes including fatty acid ester of straight-chain saturated monovalent alcohol, glycerin fatty acid ester, pentaerythritol fatty acid ester, diglycerin fatty acid ester, dipentaerythritol fatty acid ester and polyglycerin fatty acid ester; ester amide waxes; ketone waxes; and substituted urea compounds. Among them, ester waxes are preferable.

Among ester waxes, a compound having branches of three or more is preferable from the viewpoint of solubility to monomers upon synthesis of toners. Specific examples include glycerin tristearate, glycerin tribehenate, pentaerythritol tetrapalmitate, pentaerythritol tetrastearate, diglycerin tetrapalmitate, diglycerin tetrastearate, dipentaerythritol hexamyristate, dipentaerythritol hexapalmitate, and hexaglycerin octabehenate. These may be used alone or in combination of two or more kinds.

In the present invention, it is desirable that the amount of the release agent is generally in the range from 0.1 to 30 parts by weight, preferably from 1 to 20 parts by weight, with respect to the monovinyl monomer of 100 parts by weight.

As one of other additives, a molecular weight modifier is preferably used. Examples of the molecular weight modifier include mercaptans such as t-dodecyl mercaptan, n-dodecyl mercaptan, n-octyl mercaptan and 2,2,4,6,6-pentamethylheptane-4-thiol; and thiuram disulfides such as tetramethyl thiuram disulfide, tetraethyl thiuram disulfide, tetrabutyl thiuram disulfide, N,N′-dimethyl-N,N′-diphenyl thiuram disulfide and N,N′-dioctadecyl-N,N′-diisopropyl thiuram disulfide. The molecular weight modifier may be added prior to or during polymerization.

In the present invention, it is desirable that the amount of the molecular weight modifier is generally in the range from 0.01 to 10 parts by weight, preferably from 0.1 to 5 parts by weight, with respect to the monovinyl monomer of 100 parts by weight.

### (2) Suspension Process of Obtaining Suspension (Droplets Forming Process)

The polymerizable monomer composition obtained in “(1)

Preparation process of polymerizable monomer composition” is suspended in an aqueous dispersion medium, thus, a suspension (polymerizable monomer composition dispersion liquid) is obtained. Herein, “suspension” means that droplets of the polymerizable monomer composition are formed in the aqueous dispersion medium. Dispersion treatment for forming the droplets may be performed by means of a device capable of strong stirring such as an in-line type emulsifying and dispersing machine (product name: EBARA MILDER; manufactured by Ebara Corporation), and a high-speed emulsification dispersing machine (product name: T. K. HOMOMIXER MARK II; manufactured by PRIMIX Corporation).

In the present invention, the aqueous dispersion medium may be water alone but any of water-soluble solvents such as lower alcohols and lower ketones may be used together.

A dispersion stabilizer is preferably contained in the aqueous dispersion medium. Examples of the dispersion stabilizer include metallic compounds including sulfates such as barium sulfate and calcium sulfate; carbonates such as barium carbonate, calcium carbonate and magnesium carbonate; phosphates such as calcium phosphate; metallic oxides such as aluminum oxide and titanium oxide; and metallic hydroxides such as aluminum hydroxide, magnesium hydroxide and ferric hydroxide; and organic compounds including water-soluble polymers such as polyvinyl alcohol, methyl cellulose and gelatin; anionic surfactants; nonionic surfactants; and ampholytic surfactants.

Among the dispersion stabilizers, any of the metallic compounds, particularly, a dispersion stabilizer containing colloid of hardly water-soluble metal hydroxide is preferable, since the particle distribution of the colored resin particles can be narrowed and the residual amount of the dispersion stabilizer after washing can be small, so that the polymerized toner to be obtained can reproduce clear images, particularly, image quality under the high humid and high temperature environment is less likely to deteriorate.

The dispersion stabilizer may be used alone or in combination of two or more kinds. The added amount of the dispersion stabilizer is preferably in the range from 0.1 to 20 parts by weight, more preferably from 0.2 to 10 parts by weight, with respect to the polymerizable monomer of 100 parts by weight.

Examples of a polymerization initiator include persulfates such as potassium persulfate and ammonium persulfate; azo compounds such as 4,4′-azobis(4-cyanovaleric acid), 2,2′-azobis(2-methyl-N-(2-hydroxyethyl)propionamide, 2,2′-azobis(2-amidinopropane)dihydrochloride, 2,2′-azobis(2,4-dimethylvaleronitrile) and 2,2′-azobisisobutyronitrile; and organic peroxides such as di-t-butylperoxide, benzoylperoxide, t-butylperoxy-2-ethylhexanoate, t-hexylperoxy-2-ethylhexanoate, t-butylperoxypyvalate, t-butyl-2-ethylbutanoate, diisopropylperoxydicarbonate, di-t-butylperoxyisophthalate and t-butylperoxyisobutyrate. Among the above, the organic peroxides are preferably used since the residue amount of the polymerizable monomer can be reduced and printing durability is excellent.

The polymerization initiator may be added after dispersing the polymerizable monomer composition to the aqueous dispersion medium and before forming droplets as described above, or may be added to the polymerizable monomer composition.

The added amount of the polymerization initiator used in polymerization of the polymerizable monomer composition is preferably in the range from 0.1 to 20 parts by weight, more preferably from 0.3 to 15 parts by weight, further more preferably from 1.0 to 10 parts by weight, with respect to the monovinyl monomer of 100 parts by weight.

### (3) Polymerization Process

The desirable suspension (the aqueous dispersion medium containing droplets of the polymerizable monomer composition) obtained in “(2) Suspension process of obtaining a suspension (droplets forming process)” is heated to polymerize. Thereby, an aqueous dispersion liquid of colored resin particles can be obtained.

In the present invention, the polymerization temperature is preferably 50° C. or more, more preferably in the range from 60 to 98° C. The polymerization reaction time is preferably in the range from 1 to 20 hours, more preferably from 2 to 15 hours.

In order to polymerize droplets of the polymerizable monomer composition in a stably dispersed state, the polymerization reaction may proceed while agitating the droplets for dispersion treatment in the polymerization process continuously after “(2) Suspension process of obtaining suspension (droplets forming process)”.

In the present invention, it is preferable to form a so-called core-shell type (or “capsule type”) colored resin particle, which can be obtained by using the colored resin particle obtained by the polymerization process as a core layer and forming a shell layer, a material of which is different from that of the core layer, around the core layer.

The core-shell type colored resin particles can take a balance of lowering of fixing temperature and prevention of blocking at storage of the toner by covering the core layer including a substance having a low-softening point with a substance having a high softening point.

A method for producing the core-shell type colored resin particles mentioned above is not particularly limited, and may be produced by any conventional method. The in situ polymerization method and the phase separation method are preferable from the viewpoint of production efficiency.

A method of producing the core-shell type colored resin particles according to the in situ polymerization method will be hereinafter described.

A polymerizable monomer (a polymerizable monomer for shell) for forming a shell layer and a polymerization initiator for shell are added to an aqueous dispersion medium to which the colored resin particles are dispersed followed by polymerization, thus the core-shell type colored resin particles can be obtained.

As the polymerizable monomer for shell, the above described polymerizable monomers can be similarly used. Among the above, any of monomers which provide a polymer having “Tg” of more than 80° C. such as styrene and methyl methacrylate may be preferably used alone or in combination of two or more kinds.

Examples of the polymerization initiator for shell used for polymerization of the polymerizable monomer for shell include polymerization initiators including metal persulfates such as potassium persulfate and ammonium persulfate; and water-soluble azo compounds such as 2,2′-azobis-(2-methyl-N-(2-hydroxyethyl)propionamide) and 2,2′-azobis-(2-methyl-N-(1,1-bis(hydroxymethyl)₂-hydroxy ethyl)propionamide).

In the present invention, the added amount of the polymerization initiator for shell is preferably in the range from 0.1 to 30 parts by weight, more preferably from 1 to 20 parts by weight, with respect to the polymerizable monomer for shell of 100 parts by weight.

The polymerization temperature of the shell layer is preferably 50° C. or more, more preferably in the range from 60 to 95° C. Also, the polymerization time of the shell layer is preferably in the range from 1 to 20 hours, more preferably from 2 to 15 hours.

### (4) Processes of Washing, Filtering, Dehydrating and Drying

It is preferable that the aqueous dispersion liquid of the colored resin particles obtained after “(3) Polymerization process” is subjected to a series of operations including washing, filtering, dehydrating, and drying several times as needed according to any conventional method.

Firstly, in order to remove the dispersion stabilizer remained in the aqueous dispersion liquid of the colored resin particles, acid or alkali is added to the aqueous dispersion liquid of the colored resin particles to wash.

If the dispersion stabilizer being used is an acid-soluble inorganic compound, acid is added to the aqueous dispersion liquid of the colored resin particles. On the other hand, if the dispersion stabilizer being used is an alkali-soluble inorganic compound, alkali is added to the aqueous dispersion liquid of the colored resin particles.

If the acid-soluble inorganic compound is used as the dispersion stabilizer, it is preferable to control pH of the aqueous dispersion liquid of the colored resin particles to 6.5 or less by adding acid. It is more preferable to control pH to 6 or less. Examples of the acid to be added include inorganic acids such as sulfuric acid, hydrochloric acid and nitric acid, and organic acids such as formic acid and acetic acid. Particularly, sulfuric acid is suitable for high removal efficiency of the dispersion stabilizer and small impact on production facilities.

### (B) Pulverization Method

In the case of producing the colored resin particles by employing the pulverization method, the following processes are performed.

Firstly, a binder resin, a colorant, a charge control agent, and if required, other additives to be added such as a release agent are mixed by means of a mixer such as a ball mill, a V type mixer, Henschel Mixer (product name), a high-speed dissolver, an internal mixer and a whole burg internal mixer. Next, the mixture obtained is kneaded while heating by means of a press kneader, a twin screw kneading machine or a roller. The obtained kneaded product is crushed by means of a pulverizer such as a hammer mill, a cutter mill or a roller mill, followed by finely pulverizing by means of a pulverizer such as a jet mill or a high-speed rotary pulverizer, and classifying into desired particle diameters by means of a classifier such as a wind classifier or an airflow classifier. Thus, colored resin particles produced by the pulverization method can be obtained.

The binder resin, the colorant, the charge control agent, and if required, other additives to be added such as the release agent used in “(A) Suspension polymerization method” can be used in the pulverization method. Similarly as the colored resin particles obtained by “(A) Suspension polymerization method”, the colored resin particles obtained by the pulverization method can also be in a form of the core-shell type colored resin particles produced by a method such as the in situ polymerization method.

### (5) Colored Resin Particle

The colored resin particles can be obtained by “(A) Suspension polymerization method” or “(B) Pulverization method”.

The colored resin particles constituting the toner will be hereinafter described. Hereinafter, the colored resin particles include both core-shell type colored resin particles and colored resin particles which are not core-shell type.

The volume average particle diameter “Dv” of the colored resin particles of the present invention is preferably in the range from 5 to 15 μm, more preferably from 6 to 12 μm, even more preferably from 7 to 10 μm, from the viewpoint of image reproducibility.

If “Dv” of the colored resin particles is less than the above range, the flowability of the toner lowers and deterioration of image quality due to fog or the like tends to occur. On the other hand, if “Dv” of the colored resin particles exceeds the above range, the resolution of images to be obtained may decrease.

As for the colored resin particles in the present invention, a particle size distribution (Dv/Dp), which is the ratio of a volume average particle diameter “Dv” and a number average particle size “Dp”, is preferably in the range from 1.0 to 1.3, more preferably from 1.0 to 1.2, from the viewpoint of image reproducibility.

If the particle size distribution (Dv/Dp) of the colored resin particles exceeds the above range, the flowability of the toner lowers and deterioration of image quality due to fog or the like tends to occur.

The value of “Dv” and “Dp” of the colored resin particles may be measured by means of a particle diameter measuring device.

The average circularity of the colored resin particles of the present invention is preferably in the range from 0.96 to 1.00, more preferably from 0.97 to 1.00, further more preferably from 0.98 to 1.00, from the viewpoint of image reproducibility.

If the average circularity of the colored resin particles is less than the above range, the reproductivity of thin lines may decrease.

In the present invention, circularity is a value obtained by dividing a perimeter of a circle having an area same as a projected area of a particle by a perimeter of a particle image. Also, in the present invention, an average circularity is used as a simple method of quantitatively presenting shapes of particles and is an indicator showing the level of convexo-concave shapes of the colored resin particle. The average circularity is “1” when the colored resin particle is an absolute sphere, and becomes smaller as the shape of the surface of the colored resin particle becomes more complex. In order to obtain the average circularity (Ca), firstly, the circularity (Ci) of each of measured “n” particles of 0.6 μm or more by the diameter of an equivalent circle is calculated by the following Calculation formula 1. Next, the average circularity (Ca) is obtained by the following Calculation formula 2.

Circularity (Ci)=a perimeter of a circle having an area same as a projected area of a particle/a perimeter of a particle image Calculation formula 1:

$$Ca = \frac{{\sum }_{i = 1}^{n} ( Ci \times fi )}{{\sum }_{i = 1}^{n} ( fi )} \qquad Calculation formula 2$$

In Calculation formula 2, “fi” is the frequency of particles of circularity (Ci).

The above circularity and average circularity may be measured by means of any of flow particle image analyzers FPIA-2000, FPIA-2100 and FPIA-3000 (product name; manufactured by Sysmex Co.).

### (6) External Addition Process

The colored resin particles obtained in “(A) Suspension polymerization method” or “(B) Pulverization method” are mixed and agitated together with the external additives specified in the present invention. Thereby, the microparticles of the external additives can be suitably attached by addition on the surface of the colored resin particles.

A method for attaching or externally adding the external additives specified in the present invention on the surface of the colored resin particles is not particularly limited. The method may be performed using a device capable of mixing and agitating including, for example, high speed agitators such as Henschel Mixer (product name; manufactured by NIPPON COKE & ENGINEERING CO., LTD.), SUPER MIXER (product name; manufactured by KAWATA MFG Co., Ltd.), Q MIXER (product name; manufactured by NIPPON COKE & ENGINEERING CO., LTD.), Mechanofusion system (product name; manufactured by Hosokawa Micron Corporation), MECHANOMILL (product name; manufactured by OKADA SEIKO CO., LTD.) and Nobilta (product name; manufactured by Hosokawa Micron Corporation).

The external additives specified in the present invention are fatty acid alkali metal salt particles and fatty acid alkaline earth metal salt particles.

In the present invention, “fatty acid alkali metal salt particles” and “fatty acid alkaline earth metal salt particles” used as the external additives mean salt particles of fatty acid and alkali metal, and salt particles of fatty acid and alkaline earth metal respectively.

“Fatty acid” means carboxylic acid (R—COOH) having one carboxyl group (—COOH) and having a chain structure.

In the present invention, it is preferable that fatty acid constituting fatty acid alkali metal salt and fatty acid alkaline earth metal salt is fatty acid (higher fatty acid) in which an alkyl group (R—) has a large number of carbon atoms.

Examples of the higher fatty acid include lauric acid (CH₃(CH₂)₁₀COOH), tridecanoic acid (CH₃(CH₂)₁₁COOH), myristic acid (CH₃(CH₂)₁₂COOH), pentadecanoic acid (CH₃(CH₂)₁₃COOH), palmitic acid (CH₃(CH₂)₁₄COOH), heptadecanoic acid (CH₃(CH₂)₁₅COOH), stearic acid (CH₃(CH₂)₁₆COOH), arachidic acid (CH₃(CH₂)₁₈COOH), behenic acid (CH₃(CH₂)₂₀COOH) and lignoceric acid (CH₃(CH₂)₂₂COOH).

The fatty acid alkali metal salt particles and fatty acid alkaline earth metal salt particles used as the external additives in the present invention are salt particles of fatty acid and alkali metal (Li, Na, K, Rb and Cs), and salt particles of fatty acid and alkaline earth metal (Be, Mg, Ca, Sr and Ba) respectively.

Specific examples of the fatty acid alkali metal salt and fatty acid alkaline earth metal salt include alkali metal laurates such as lithium laurate, sodium laurate and potassium laurate; alkaline earth metal laurates such as magnesium laurate, calcium laurate and barium laurate; alkali metal myristates such as lithium myristate, sodium myristate and potassium myristate; alkaline earth metal myristates such as magnesium myristate, calcium myristate and barium myristate; alkali metal palmitates such as lithium palmitate, sodium palmitate and potassium palmitate; alkaline earth metal palmitates such as magnesium palmitate, calcium palmitate and barium palmitate; alkali metal stearates such as lithium stearate, sodium stearate and potassium stearate; and alkaline earth metal stearates such as magnesium stearate, calcium stearate and barium stearate.

Among the above, fatty acid alkali metal salt particles or fatty acid alkaline earth metal salt particles having a number average primary particle diameter in the range from 0.1 to 1 μm are used as the external additive in the present invention.

The fatty acid alkali metal salt and fatty acid alkaline earth metal salt exemplified above are not particularly limited as long as they are fatty acid alkali metal salt particles and fatty acid alkaline earth metal salt particles having the number average primary particle diameter (0.1 to 1 μm) specified in the present invention. Carbon atoms of the alkyl group of the fatty acid constituting fatty acid alkali metal salt and fatty acid alkaline earth metal salt are preferably in the range from 12 to 24, more preferably from 14 to 22, further more preferably from 16 to 20. Also, it is preferable that alkali metal is lithium, and alkaline earth metal is magnesium or calcium.

Specific examples of the fatty acid alkali metal salt and fatty acid alkaline earth metal salt, which are preferably used in the present invention, include lithium stearate, magnesium stearate and calcium stearate.

As the fatty acid alkali metal salt particles and the fatty acid alkaline earth metal salt particles having the number average primary particle diameter (0.1 to 1 μm) specified in the present invention, various types of commercial products can be used. Examples of commercial products manufactured by Sakai Chemical Industry Co., Ltd. include SPL-100F (product name; lithium stearate; number average primary particle diameter: 0.71 μm), SPX-100F (product name; magnesium stearate; number average primary particle diameter: 0.72 μm) and SPC-100F (product name; calcium stearate; number average primary particle diameter: 0.51 μm).

The number average primary particle diameter of the fatty acid alkali metal salt particles or the fatty acid alkaline earth metal salt particles used as the external additive in the present invention is in the range from 0.1 to 1 μm, preferably from 0.2 to 0.8 μm.

If the number average primary particle diameter of the fatty acid alkali metal salt particles or the fatty acid alkaline earth metal salt particles is within the above range, the toner which is excellent in initial charging speed, and thus producing less initial fog and being less likely to cause filming on photosensitive members upon initial printing soon after replenishment of the toners, can impart a stable charging ability to toner particles over time, and thus hardly causes deterioration of image quality due to fog or the like, and therefore is excellent in printing durability even if continuous printing of a large number of prints is performed, can be obtained.

If the number average primary particle diameter of the fatty acid alkali metal salt particles or the fatty acid alkaline earth metal salt particles is less than the above range, filming on photosensitive members tends to occur, thus deterioration of image quality due to fog or the like upon printing tends to occur, therefore adverse effect on printing performance may be caused. On the other hand, if the number average primary particle diameter of the fatty acid alkali metal salt particles or the fatty acid alkaline earth metal salt particles exceeds the above range, initial charging speed decreases upon initial printing soon after replenishment of the toners, and a stable charging ability cannot be imparted to toner particles over time, thus deterioration of image quality due to fog or the like upon printing tends to occur, and therefore adverse effect on printing performance may be caused.

The content of the fatty acid alkali metal salt particles or the fatty acid alkaline earth metal salt particles used as the external additive in the present invention is in the range from 0.01 to 0.5 parts by weight, preferably from 0.01 to 0.3 parts by weight, more preferably from 0.02 to 0.2 parts by weight, with respect to 100 parts by weight of the colored resin particles.

The fatty acid alkali metal salt particles or the fatty acid alkaline earth metal salt particles may be used alone or in combination of two or more kinds as the external additive.

If the content of the fatty acid alkali metal salt particles or the fatty acid alkaline earth metal salt particles is within the above range, the toner which is excellent in initial charging speed, and thus producing less initial fog and being less likely to cause filming on photosensitive members upon initial printing soon after replenishment of the toners, can impart a stable charging ability to toner particles over time, and thus hardly causes deterioration of image quality due to fog or the like, and therefore is excellent in printing durability even if continuous printing of a large number of prints is performed, can be obtained.

If the content of the fatty acid alkali metal salt particles or the fatty acid alkaline earth metal salt particles is less than the above range, the desired functions as the external additive cannot be obtained so that filming on photosensitive members tends to occur, thus deterioration of image quality due to fog or the like upon printing tends to occur, therefore adverse effect on printing performance may be caused. On the other hand, if the content of the fatty acid alkali metal salt particles or the fatty acid alkaline earth metal salt particles exceeds the above range, initial charging speed decreases and thus being likely to cause filming on photosensitive members upon initial printing soon after replenishment of the toners so that a stable charging ability cannot be imparted to toner particles over time, thus deterioration of image quality due to fog or the like upon printing tends to occur, and therefore adverse effect on printing performance may be caused.

The fatty acid alkali metal salt particles or the fatty acid alkaline earth metal salt particles used as the external additive in the present invention may be subjected to hydrophobicity-imparting treatment. Examples of a hydrophobicity-imparting treatment agent to be used include silane coupling agents and silicone oils.

Examples of the silane coupling agents include disilazanes such as hexamethyldisilazane; cyclic silazanes; alkylsilane compounds such as trimethylsilane, trimethylchlorosilane, dimethyldichlorosilane, methyltrichlorosilane, allyldimethylchlorosilane, benzyl dimethylchlorosilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-butyltrimethoxysilane, n-hexadecyltrimethoxysilane, n-octadecyltrimethoxysilane, vinyltrimethoxysilane, vinyltriethoxysilane, γ-methacryloxypropyltrimethoxysilane and vinyltriacetoxysilane; and aminosilane compounds such as γ-aminopropyltriethoxysilane, γ-(2-aminoethyl)aminopropyltrimethoxysilane, γ-(2-aminoethyl)aminopropylmethyldimethoxysilane, N-phenyl-3-aminopropyltrimethoxysilane, N-(2-aminoethyl)3-aminopropyltrimethoxysilane, and N-β-(N-vinylbenzylaminoethyl)-γ-aminopropyltrimethoxysilane

Examples of the silicone oils include dimethylpolysiloxane, methylhydrogenpolysiloxane, methylphenylpolysiloxane and amino modified silicone oils.

The hydrophobicity-imparting treatment agent may contain one or more kinds of the above agents. It is more preferable to use any of silane coupling agents or silicone oils since the toner to be obtained can provide high image quality.

As a method of the hydrophobicity-imparting treatment of the fatty acid alkali metal salt particles or the fatty acid alkaline earth metal salt particles used as the external additive in the present invention, any of general methods such as a dry method and a wet method may be used.

The specific examples include a method in which the above described hydrophobicity-imparting treatment agent is added dropwise or sprayed while agitating the fatty acid alkali metal salt particles or the fatty acid alkaline earth metal salt particles used as the external additive at high speed, and a method in which the above described hydrophobicity-imparting treatment agent is dissolved in an organic solvent, and the fatty acid alkali metal salt particles or the fatty acid alkaline earth metal salt particles are added while agitating the organic solvent containing the hydrophobicity-imparting treatment agent.

In the present invention, silica particles (A) or silica particles (B) having the number average primary particle diameter specified below are preferably used besides the external additive (the fatty acid alkali metal salt particles, or the fatty acid alkaline earth metal salt particles) specified in the present invention. It is more preferable that the silica particles (A) and the silica particles (B) are used together.

In the present invention, in the case that the external additives (the silica particles (A) and the silica particles (B)) having different particle diameter are used together besides the external additives (the fatty acid alkali metal salt particles and the fatty acid alkaline earth metal salt particles) specified in the present invention, external addition may be performed at once by charging the colored resin particles and all kinds of external additives in a high-speed agitator. However, it is preferable that only the colored resin particles and the external additive having relatively large particle diameter are firstly charged in a high-speed agitator and the external additive is externally added, and then, the external additive having relatively small particle diameter are further charged and the external additives are externally added.

The number average primary particle diameter of the silica particles (A) is preferably in the range from 5 to 18 nm, more preferably from 6 to 16 nm, further more preferably from 7 to 14 nm.

If the number average primary particle diameter of the silica particles (A) is less than the above range, the silica particles (A) are easily buried on the surface of toner particles, thus deterioration of image quality due to fog or the like upon printing tends to occur, and therefore adverse effect on printing performance may be caused.

The number average primary particle diameter of the silica particles (B) is preferably in the range from 20 to 80 nm, more preferably from 25 to 65 nm, further more preferably from 30 to 50 nm.

If the number average primary particle diameter of the silica particles (B) exceeds the above range, the flowability of the toners lowers, thus deterioration of image quality due to fog or the like upon printing tends to occur, and therefore adverse effect on printing performance may be caused.

As the silica particles (A) preferably used in the present invention, various types of commercial products can be used. Examples of commercial products include HDK H2150VP (product name; manufactured by Clariant; number average primary particle diameter: 12 nm); NA200Y (product name; manufactured by NIPPON AEROSIL CO., LTD.; number average primary particle diameter: 12 nm), RA200HS (product name; manufactured by NIPPON AEROSIL CO., LTD.; number average primary particle diameter: 12 nm), MSP-012 (product name; manufactured by Tayca Corporation; number average primary particle diameter: 16 nm) and MSP-013 (product name; manufactured by Tayca Corporation; number average primary particle diameter: 12 nm).

As the silica particles (B) preferably used in the present invention, various types of commercial products can be used. Examples of commercial products include NA50Y (product name; manufactured by NIPPON AEROSIL CO., LTD.; number average primary particle diameter: 35 nm), VPNA50H (product name; manufactured by NIPPON AEROSIL CO., LTD.; number average primary particle diameter: 40 nm), MSP-011 (product name; manufactured by Tayca Corporation; number average primary particle diameter: 30 nm) and H05TA (product name; manufactured by Clariant; number average primary particle diameter: 50 nm).

Both silica particles (A) and silica particles (B) are preferably subjected to hydrophobicity-imparting treatment. A hydrophobicity-imparting treatment agent and a method of the hydrophobicity-imparting treatment may be the same as the external additive (the fatty acid alkali metal salt particles and the fatty acid alkaline earth metal salt particles).

The content of the silica particles (A) is preferably in the range from 0.1 to 3 parts by weight, more preferably from 0.2 to 2.5 parts by weight, further more preferably from 0.3 to 2 parts by weight, with respect to 100 parts by weight of the colored resin particles.

If the content of the silica particles (A) is less than the above range, the flowability of the toners lowers, thus blur on images may be generated. On the other hand, if the content of the silica particles (A) exceeds the above range, fixing ability may be deteriorated.

The content of the silica particles (B) is preferably in the range from 0.1 to 3 parts by weight, more preferably from 0.3 to 2.5 parts by weight, further more preferably from 0.4 to 2 parts by weight, with respect to 100 parts by weight of the colored resin particles.

If the content of the silica particles (B) is less than the above range, the charge amount decreases, thus fog on images may be generated. On the other hand, if the content of the silica particles (B) exceeds the above range, the flowability of the toners lowers, thus blur on images may be generated.

### (7) Toner

The toner obtained as a result of the processes (1) to (6) uses a specific amount of the fatty acid alkali metal salt particles or the fatty acid alkaline earth metal salt particles having a specific number average primary particle diameter as the external additive, thereby, the toner is applicable to a toner replenishment-type image forming device, is excellent in charge stability of toners and initial charging speed, and thus producing less initial fog and being less likely to cause filming on photosensitive members upon initial printing soon after replenishment of the toners, can impart a stable charging ability to toner particles over time, and thus hardly causes deterioration of image quality due to fog or the like, and therefore is excellent in printing durability even if continuous printing of a large number of prints is performed.

### EXAMPLES

Hereinafter, the present invention will be explained further in detail with reference to examples and comparative examples. However, the scope of the present invention may not be limited to the following examples. Herein, “part(s)” and “%” are based on weight if not particularly mentioned.

Test methods used in the examples and the comparative examples are as follows.

### (1) Number Average Primary Particle Diameter of External Additive

The number average primary particle diameter of an external additive was determined by: taking an electron micrograph of particles of the external additive; and calculating the arithmetic mean value of diameters of the equivalent circles corresponding to projected areas of the particles in the electron micrograph under the condition that the area ratio of particles to a frame area is up to 2% and the total number of analyzed particles is 100, by means of an image analyzing system (product name: LUZEX IID; manufactured by NIRECO CORPORATION).

### (2) Colored Resin Particles

### (2-1) Volume Average Particle Diameter “Dv” and Particle Size Distribution “Dv/Dp”

About 0.1 g of a test sample (colored resin particles) was weighed and charged into a beaker. Then, an aqueous solution of alkyl benzene sulfonate (product name: DRIWEL; manufactured by FUJIFILM Corporation) of 0.1 ml was added therein as a dispersant. Further, from 10 to 30 ml of ISOTON II was added to the beaker. The mixture was dispersed by means of an ultrasonic disperser at 20 watts for 3 minutes. Then, the volume average particle diameter “Dv” and the number average particle diameter “Dp” of the colored resin particles were measured by means of a particle diameter measuring device (product name: MULTISIZER; manufactured by Beckman Coulter, Inc.) under the condition of an aperture diameter of 100 μm, using ISOTON II as a medium, and a number of the measured particles of 100,000. Therefrom, the particle size distribution (Dv/Dp) was calculated.

### (2-2) Average Circularity

Into a container pre-filled with ion-exchanged water of 10 ml, a surfactant (alkyl benzene sulfonate) of 0.02 g as a dispersant and colored resin particles of 0.02 g were charged. Then, dispersion treatment was performed by means of an ultrasonic disperser at 60 watts for 3 minutes. The density of colored resin particles during measurement was adjusted to be 3,000 to 10,000 particles/μL, and 1,000 to 10,000 colored resin particles having a diameter of 0.4 μm or more by a diameter of the equivalent circle were subjected to measurement by means of a flow particle image analyzer (product name: FPIA-2100; manufactured by Sysmex Co.). The average circularity was calculated from measured values thus obtained.

Circularity can be calculated by the following Calculation formula 1, and the average circularity is an average of calculated circularities:

Circularity=a perimeter of a circle having an area same as a projected area of a particle/a perimeter of a projected image of a particle Calculation formula 1:

### (3) Charge Amount of Toners

A commercially available printer of the non-magnetic one-component developing method (product name: HL-5040; manufactured by BROTHER INDUSTRIES, LTD.; printing speed: 18 prints in A4 size per minute) was charged with printing papers and provided with a cartridge charged with a toner. After the printer was left under the N/N (normal temperature and humidity) environment having a temperature of 23° C. and a humidity of 50% for 24 hours, printing with 5% image density was performed under the N/N environment up to 5 prints. Then, the charge amount of the toner attached on a developing roller was measured by means of a suction type Q/m analyzer (product name: 210HS-2A; manufactured by Trek Japan KK.), and converted to the charge amount per unit weight of the toners (μC/g).

### (4) Evaluation of Image Quality of Toners

### (4-1) Printing Durability

A commercially available printer of the non-magnetic one-component developing method (product name: HL-5040; manufactured by BROTHER INDUSTRIES, LTD.; printing speed: 18 prints in A4 size per minute) was charged with printing papers and provided with a cartridge charged with a toner. After the printer was left under the N/N (normal temperature and humidity) environment having a temperature of 23° C. and a humidity of 50% for 24 hours, continuous printing with 5% image density was performed under the N/N environment up to 12,000 prints to measure a fog value every 500 prints.

The fog value was measured as follows.

A solid patterned image with 100% image density was printed every 500 prints and the image density of the solid patterned image was measured by means of a reflection image densitometer (product name: RD918; manufactured by Gretag Macbeth Co.). Further, after a solid patterned image with 0% image density was printed with the printer followed by stopping solid pattern printing in mid-course, the toner remained in a non-image area on the photosensitive member after development was attached to an adhesive tape (product name: SCOTCH MENDING TAPE 810-3-18; manufactured by Sumitomo 3M Limited). The tape was attached to a new printing paper, and the whiteness (B) of the printing paper with the tape was measured by means of a whiteness colorimeter (product name: NDW-1D, manufactured by NIPPON DENSHOKU INDUSTRIES CO., LTD.). Similarly, an unused tape was attached to a printing paper to measure the whiteness (A). The difference of whiteness (B-A) was referred to as a fog value. As the fog value decreases, it means that less fog is produced and image quality is excellent.

The number of prints by continuous printing, which can maintain the image quality having an image density of 1.3 or more and a fog value of 3 or less, was counted.

In Table 1, the number of prints having fog generation of “12,000<” means that image quality having fog value of 3 or less was maintained at the time of 12,000 prints.

(4-2) Initial Fog Soon after Replenishment of Toners

After the above test in “(4-1) printing durability”, 30 g of the remaining toners in the development device was left and 100 g of new toners were replenished therein. After a solid patterned image with 0% image density was printed followed by stopping solid pattern printing in mid-course, the toner remained in a non-image area on the photosensitive member after development was attached to an adhesive tape (product name: SCOTCH MENDING TAPE 810-3-18; manufactured by Sumitomo 3M Limited). The tape was attached to a new printing paper, and the whiteness (B) of the printing paper with the tape was measured by means of a whiteness colorimeter (product name: NDW-1D; manufactured by NIPPON DENSHOKU INDUSTRIES CO., LTD.). Similarly, an unused tape was attached to a printing paper to measure the whiteness (A). The difference of whiteness (B-A) was referred to as a fog value. As the fog value decreases, it means that less fog is produced and image quality is excellent.

At the time of printing soon after replenishment of toners, the fog value was 3 or more. However, the fog value gradually decreased every time printing was performed. The number of prints at the time that the fog value was 3 or less by printing was counted and this value was referred to as the number of prints having initial fog disappearance soon after replenishment of the toners.

### (4-3) Filming

A commercially available printer of the non-magnetic one-component developing method (product name: HL-5040; manufactured by BROTHER INDUSTRIES, LTD.; printing speed: 18 prints in A4 size per minute) was charged with printing papers and provided with a cartridge charged with a toner. After the printer was left under the N/N (normal temperature and humidity) environment having a temperature of 23° C. and a humidity of 50% for 24 hours, printing test with 1% image density was performed under the N/N environment. A halftone patterned image with 50% image density was printed every 500 prints and generation of filming on the photosensitive member was confirmed.

The number of prints when the whitely fuzzy image was firstly confirmed on the halftone patterned image was counted as the number of prints having filming generation, and the printing test was performed up to 10,000 prints.

In Table 1, the number of prints having filming generation of “10,000<” means that filming on the photosensitive member did not generate at the time of 10,000 prints.

### Example 1

83 parts of styrene and 17 parts of n-butyl acrylate as monovinyl monomers (calculated Tg of copolymer to be obtained=60° C.), 7 parts of carbon black (product name: #25B; manufactured by Mitsubishi Chemical Corporation) as a black colorant, 1 part of a charge control agent having positively charging ability (product name: FCA-207P; manufactured by Fujikura Kasei Co., Ltd.; a styrene/acrylate resin), 0.6 parts of divinylbenzene as a crosslinkable monomer, 1.9 parts of t-dodecyl mercaptan as a molecular weight modifier and 0.25 parts of polymethacrylic acid ester macromonomer (product name: AA6; manufactured by Toagosei Co., Ltd.) as a macromonomer were agitated by means of an agitator to mix followed by uniform dispersion by a media type dispersing machine. Thereto, 5 parts of dipentaerythritol hexamyristate as a release agent was added, mixed and dissolved. Thus, a polymerizable monomer composition was obtained.

Separately, an aqueous solution of 6.2 parts of sodium hydroxide (alkali hydroxide metal) dissolved in 50 parts of ion-exchanged water was gradually added to an aqueous solution of 10.2 parts of magnesium chloride (water-soluble polyvalent metallic salt) dissolved in 250 parts of ion-exchanged water at room temperature while agitating to prepare a magnesium hydroxide colloid (hardly water-soluble metal hydroxide colloid) dispersion liquid.

The polymerizable monomer composition was charged into the magnesium hydroxide colloid dispersion liquid thus obtained and agitated at room temperature until droplets are stable. Then, 6 parts of t-butylperoxy-2-ethylhexanoate (product name: PERBUTYL 0; manufactured by NOF Corporation) as a polymerization initiator was added therein. The mixture was subjected to a high shear agitation at 15,000 rpm for 10 minutes by means of an in-line type emulsifying and dispersing machine (product name: EBARA MILDER; manufactured by Ebara Corporation) to form droplets of the polymerizable monomer composition.

The thus obtained suspension having droplets of the polymerization monomer composition dispersed (a polymerizable monomer composition dispersion liquid) was charged into a reactor furnished with an agitating blade and the temperature thereof was raised to 90° C. to start a polymerization reaction. When the polymerization conversion rate reached almost 100%, a dispersion obtained by mixing 1 part of methyl methacrylate (a polymerizable monomer for shell) and 10 parts of ion-exchanged water, and 0.3 parts of 2,2′-azobis (2-methyl-N-(2-hydroxyethyl)-propionamide) (product name: VA-086; manufactured by Wako Pure Chemical Industries, Ltd.; a polymerization initiator for shell) dissolved in 20 parts of ion-exchanged water were added in the reactor. After continuing the polymerization for 4 hours at 90° C., the reactor was cooled to room temperature to obtain an aqueous dispersion of colored resin particles.

The thus obtained aqueous dispersion of colored resin particles was subjected to acid washing in which sulfuric acid was added to be pH of 6.0 or less. After dehydrating by filtration, the aqueous dispersion of colored resin particles was subjected to water washing in which another 500 parts of ion-exchanged water was added to make a slurry again. After repeating a series of dehydration and water washing several times, the colored resin particles were dehydrated by filtration and charged into a container of a dryer for drying at 45° C. for 48 hours. Thus, dried colored resin particles were obtained.

The volume average particle diameter “Dv” of the colored resin particles obtained was 9.7 μm, and the particle size distribution “Dv/Dp” was 1.14. The average circularity was 0.983.

To the colored resin particles thus obtained of 100 parts, 0.1 part of magnesium stearate particles (product name: SPX-100F; manufactured by Sakai Chemical Industry Co., Ltd.; number average primary particle diameter: 0.72 μm), which are fatty acid alkaline earth metal salt particles as an external additive specified in the present invention, 0.9 parts of silica particles (A) subjected to hydrophobicity-imparting treatment (product name: HDK H2150VP; manufactured by Clariant; number average primary particle diameter: 12 nm) and 1.3 parts of silica particles (B) subjected to hydrophobicity-imparting treatment (product name: NA50Y; manufactured by Nippon Aerosil Co., Ltd.; number average primary particle diameter: 35 nm) as other external additives were added and mixed by means of a high speed agitator (product name: Henschel Mixer; manufactured by NIPPON COKE & ENGINEERING CO., LTD.) at a peripheral speed of 30 m/s for 6 minutes, and the external additives were externally added. Thus, a non-magnetic one-component positively-chargeable toner for developing electrostatic images of Example 1 was produced, and used for testing.

### Example 2

A toner of Example 2 was produced similarly as Example 1 except that the kind and the added amount of the external additive specified in the present invention in Example 1 was changed to 0.15 parts of calcium stearate particles (product name: SPC-100F; manufactured by Sakai Chemical Industry Co., Ltd.; number average primary particle diameter: 0.51 μm), which are fatty acid alkaline earth metal salt particles, and was used for testing.

### Example 3

A toner of Example 3 was produced similarly as Example 1 except that the kind and the added amount of the external additive specified in the present invention in Example 1 was changed to 0.15 parts of lithium stearate particles (product name: SPL-100F; manufactured by Sakai Chemical Industry Co., Ltd.; number average primary particle diameter: 0.71 μm), which are fatty acid alkali metal salt particles, and was used for testing.

### Example 4

A toner of Example 4 was produced similarly as Example 1 except that the silica particles (A) in Example 1 were not added as other external additives, and was used for testing.

### Example 5

A toner of Example 5 was produced similarly as Example 1 except that the charge control agent in Example 1 was changed to nigrosine (product name: BONTRON N-01; manufactured by ORIENT CHEMICAL INDUSTRIES CO., LTD.) and the silica particles (B) were not added as other external additives, and was used for testing.

### Example 6

A toner of Example 6 was produced similarly as Example 1 except that the release agent in Example 1 was changed to hexaglycerin octabehenate, and was used for testing.

### Comparative example 1

A toner of Comparative example 1 was produced similarly as Example 1 except that the kind and the added amount of the external additive specified in the present invention in Example 1 were changed to 0.15 parts of calcium stearate particles (product name: MC-2; manufactured by NOF Corporation; number average primary particle diameter: 1.2 μm), which are fatty acid alkaline earth metal salt particles, and was used for testing.

### Comparative Example 2

A toner of Comparative example 2 was produced similarly as Example 1 except that the kind and the added amount of the external additive specified in the present invention in Example 1 were changed to 0.15 parts of zinc stearate particles (product name: SPZ-100F; manufactured by Sakai Chemical Industry Co., Ltd.; number average primary particle diameter: 0.45 μm), which are fatty acid metal salt particles, and was used for testing.

### Comparative Example 3

A toner of Comparative example 3 was produced similarly as Example 1 except that the added amount of the external additive specified in the present invention in Example 1 was changed to 0.7 parts, and was used for testing.

### (Results)

The test results of Examples and Comparative examples are shown in Tables 1-1 and 1-2.

TABLE 1-1

| | | | Example 1 | Example 2 | Example 3 | Example 4 | Example 5 |
|---|---|---|---|---|---|---|---|
| External | Fatty acid | Product name | SPX-100F | SPC-100F | SPL-100F | SPX-100F | SPX-100F |
| additives | metal salt | (manufacturer) | (Sakai | (Sakai | (Sakai | (Sakai | (Sakai |
| | particles | | Chemical | Chemical | Chemical | Chemical | Chemical |
| | | | Industry | Industry | Industry | Industry | Industry |
| | | | Co., Ltd.) | Co., Ltd.) | Co., Ltd.) | Co., Ltd.) | Co., Ltd.) |
| | | Type of fatty | Stearic acid | Stearic acid | Stearic acid | Stearic acid | Stearic acid |
| | | acid (Number | (17) | (17) | (17) | (17) | (17) |
| | | of carbon | | | | | |
| | | atoms of an | | | | | |
| | | alkyl group) | | | | | |
| | | Type of metal | Mg | Ca | Li | Mg | Mg |
| | | Number average | 0.72 | 0.51 | 0.71 | 0.72 | 0.72 |
| | | primary particle | | | | | |
| | | diameter (μm) | | | | | |
| | | Added amount | 0.1 | 0.15 | 0.15 | 0.1 | 0.1 |
| | | (part) | | | | | |
| | Silica | Product name | HDK | HDK | HDK | — | HDK |
| | particles | (manufacturer) | H2150VP | H2150VP | H2150VP | | H2150VP |
| | (A) | | (Clariant) | (Clariant) | (Clariant) | | (Clariant) |
| | | Number average | 12 | 12 | 12 | — | 12 |
| | | primary particle | | | | | |
| | | diameter (nm) | | | | | |
| | | Added amount | 0.9 | 0.9 | 0.9 | — | 0.9 |
| | | (part) | | | | | |
| | Silica | Product name | NA50Y | NA50Y | NA50Y | NA50Y | — |
| | particles | (manufacturer) | (Nippon | (Nippon | (Nippon | (Nippon | |
| | (B) | | Aerosil | Aerosil | Aerosil | Aerosil | |
| | | | Co., Ltd.) | Co., Ltd.) | Co., Ltd.) | Co., Ltd.) | |
| | | Number average | 35 | 35 | 35 | 35 | — |
| | | primary particle | | | | | |
| | | diameter (nm) | | | | | |
| | | Added amount | 1.3 | 1.3 | 1.3 | 1.3 | — |
| | | (part) | | | | | |

| | | | | Comparative | Comparative | Comparative |
|---|---|---|---|---|---|---|
| | | | Example 6 | example 1 | example 2 | example 3 |
| External | Fatty acid | Product name | SPX-100F | MC-2 | SPZ-100F | SPX-100F |
| additives | metal salt | (manufacturer) | (Sakai | (NOF | (Sakai | (Sakai |
| | particles | | Chemical | Corporation) | Chemical | Chemical |
| | | | Industry | | Industry | Industry |
| | | | Co., Ltd.) | | Co., Ltd.) | Co., Ltd.) |
| | | Type of fatty | Stearic acid | Stearic acid | Stearic acid | Stearic acid |
| | | acid (Number | (17) | (17) | (17) | (17) |
| | | of carbon | | | | |
| | | atoms of an | | | | |
| | | alkyl group) | | | | |
| | | Type of metal | Mg | Ca | Zn | Mg |
| | | Number average | 0.72 | 1.2 | 0.45 | 0.72 |
| | | primary particle | | | | |
| | | diameter (μm) | | | | |
| | | Added amount | 0.1 | 0.15 | 0.15 | 0.7 |
| | | (part) | | | | |
| | Silica | Product name | HDK | HDK | HDK | HDK |
| | particles | (manufacturer) | H2150VP | H2150VP | H2150VP | H2150VP |
| | (A) | | (Clariant) | (Clariant) | (Clariant) | (Clariant) |
| | | Number average | 12 | 12 | 12 | 12 |
| | | primary particle | | | | |
| | | diameter (nm) | | | | |
| | | Added amount | 0.9 | 0.9 | 0.9 | 0.9 |
| | | (part) | | | | |
| | Silica | Product name | NA50Y | NA50Y | NA50Y | NA50Y |
| | particles | (manufacturer) | (Nippon | (Nippon | (Nippon | (Nippon |
| | (B) | | Aerosil | Aerosil | Aerosil | Aerosil |
| | | | Co., Ltd.) | Co., Ltd.) | Co., Ltd.) | Co., Ltd.) |
| | | Number average | 35 | 35 | 35 | 35 |
| | | primary particle | | | | |
| | | diameter (nm) | | | | |
| | | Added amount | 1.3 | 1.3 | 1.3 | 1.3 |
| | | (part) | | | | |

TABLE 1-2

| | | Example 1 | Example 2 | Example 3 | Example 4 | Example 5 |
|---|---|---|---|---|---|---|
| Charge | Type | Styrene/ | Styrene/ | Styrene/ | Styrene/ | Nigrosine |
| control | | Acrylate resin | Acrylate resin | Acrylate resin | Acrylate resin | |
| agent | Product name | FCA-207P | FCA-207P | FCA-207P | FCA-207P | BONTRON |
| | (manufacturer) | (Fujikura | (Fujikura | (Fujikura | (Fujikura | N-01 |
| | | Kasei Co., | Kasei Co., | Kasei Co., | Kasei Co., | (ORIENT |
| | | Ltd.) | Ltd.) | Ltd.) | Ltd.) | CHEMICAL |
| | | | | | | INDUSTRIES |
| | | | | | | CO., LTD.) |
| Charge amount of toners | | 35.1 | 33.2 | 39.2 | 50.4 | 35.2 |
| Q/M (μC/g) | | | | | | |
| Printing | Printing | 12,000< | 12,000< | 12,000< | 10,500 | 10,000 |
| test | durability (print) | | | | | |
| | Number of | 3 | 4 | 5 | 7 | 8 |
| | prints having | | | | | |
| | initial fog | | | | | |
| | disappearance | | | | | |
| | soon after | | | | | |
| | replenishment | | | | | |
| | of toner (print) | | | | | |
| | Number of | 10,000< | 10,000< | 10,000< | 10,000< | 10,000< |
| | prints having | | | | | |
| | filming | | | | | |
| | generation | | | | | |
| | (print) | | | | | |

| | | | Comparative | Comparative | Comparative |
|---|---|---|---|---|---|
| | | Example 6 | example 1 | example 2 | example 3 |
| Charge | Type | Styrene/ | Styrene/ | Styrene/ | Styrene/ |
| control | | Acrylate resin | Acrylate resin | Acrylate resin | Acrylate resin |
| agent | Product name | FCA-207P | FCA-207P | FCA-207P | FCA-207P |
| | (manufacturer) | (Fujikura | (Fujikura | (Fujikura | (Fujikura |
| | | Kasei Co., | Kasei Co., | Kasei Co., | Kasei Co., |
| | | Ltd.) | Ltd.) | Ltd.) | Ltd.) |
| Charge amount of toners | | 35.1 | 36.5 | 42.3 | 22.4 |
| Q/M (μC/g) | | | | | |
| Printing | Printing | 12,000< | 9,000 | 8,000 | Fog was |
| test | durability (print) | | | | generated |
| | | | | | from the |
| | | | | | beginning. |
| | Number of | 3 | 11 | 15 | — |
| | prints having | | | | |
| | initial fog | | | | |
| | disappearance | | | | |
| | soon after | | | | |
| | replenishment | | | | |
| | of toner (print) | | | | |
| | Number of | 10,000< | 7,000 | 10,000< | — |
| | prints having | | | | |
| | filming | | | | |
| | generation | | | | |
| | (print) | | | | |

### (Summary of Results)

The following can be found from the test results shown in Table 1.

In the toner of Comparative example 1, it took time to eliminate the initial fog generated upon the initial printing soon after replenishment of the toners, the initial charging speed was poor, and the printing durability was inferior, since the toner of Comparative example 1 used the fatty acid alkaline earth metal salt particles, the number average primary particle diameter of which exceeds the range specified in the present invention, as the external additive.

In the toner of Comparative example 2, it took further time to eliminate the initial fog generated upon the initial printing soon after replenishment of the toners than Comparative example 1, the initial charging speed was poor, and the printing durability was inferior, since the toner of Comparative example 2 used the fatty acid metal salt particles not specified in the present invention as the external additive.

The toner of Comparative example 3 generated fog from the beginning of the printing durability test and was inferior in printing performance, since the toner of Comparative example 3 used the fatty acid alkaline earth metal salt particles, the added amount of which exceeded the range specified in the present invention, as the external additive.

To the contrary, in the toners of Examples 1 to 3 and 6, it did not take time to eliminate the initial fog generated upon the initial printing soon after replenishment of the toners and the initial charging speed was excellent besides not causing filming and being excellent in printing durability, since the toners of Examples 1 to 3 and 6 used the fatty acid alkali metal salt particles, or the fatty acid alkaline earth metal salt particles specified in the present invention as the external additive.

The toner of Examples 4 and 5 were slightly inferior in printing durability and initial charging speed compared to the toners of Examples 1 to 3, since the toner of Example 4 did not use the silica particles (A) as the external additive, and the toner of Example 5 did not use the silica particles (B) as the external additive and the charge control resin as the charge control agent.

1. A positively-chargeable toner for developing electrostatic images comprising colored resin particles containing a binder resin, a colorant and a charge control agent, and an external additive,
wherein the external additive contains fatty acid alkali metal salt particles or fatty acid alkaline earth metal salt particles having a number average primary particle diameter of 0.1 to 1 μm, and a content of the fatty acid alkali metal salt particles or the fatty acid alkaline earth metal salt particles is in the range from 0.01 to 0.5 parts by weight with respect to 100 parts by weight of the colored resin particles.

2. The positively-chargeable toner for developing electrostatic images according to claim 1, wherein the charge control agent is a charge control resin.

3. The positively-chargeable toner for developing electrostatic images according to claim 1, wherein the external additive further contains silica particles (A) having a number average primary particle diameter of 5 to 18 nm.

4. The positively-chargeable toner for developing electrostatic images according to claim 1, wherein the external additive further contains silica particles (B) having a number average primary particle diameter of 20 to 80 nm.

5. The positively-chargeable toner for developing electrostatic images according to claim 1, being used in a toner replenishment-type image forming device.
